(19) United States
(12) Patent Application Publication
(10) Pub. No.: US 2026/0238745 A1
(43) Pub. Date: Aug. 13, 2026

(54) SYSTEM AND METHOD FOR CONTEXTUALIZING INCIDENTS INVOLVING MATERIAL HANDLING AND MOVING EQUIPMENT

(71) Applicant: Gestion Translogistic.net Inc., Vaudreuil-Dorion (CA)

(72) Inventors: Sean QUESNEL, Rigaud (CA); Dany RAYMOND, Rigaud (CA); Patrick LAPOINTE, Blainville (CA)

(21) Appl. No.: 19/539,672

(22) Filed: Feb. 13, 2026

Related U.S. Application Data
(60) Provisional application No. 63/758,091, filed on Feb. 13, 2025.

(51) Int. Cl. H04N 7/18; G01P 15/18; G06V 20/52

(52) U.S. Cl. CPC H04N 7/188; G01P 15/18; G06V 20/52; H04N 7/183

(57) ABSTRACT

A system and a method for notifying of an incident involving a material handling and moving equipment (MHME). The method comprises generating and recording a video data with corresponding timestamps by a video recording device; detecting acceleration forces with reference to each one of three axes, an accelerometer sensor processing the acceleration forces to determine a potential incident and corresponding timestamp and transmitting data relative to the potential incident to a server or the acceleration sensor transmitting continuously detected accelerations forces to the server; analyzing the acceleration forces within an analysis period comprising time window before and after a potential incident timestamp based on incident criteria and determining whether a detected incident has occurred; requesting and transmitting an incident videoclip; and generating a contextualized notification corresponding to the detected incident and transmitting to a manager device located remotely from the MHME.

### RELATED APPLICATION

The present application claims priority to or benefit of United States provisional patent application No. 63/758,091, filed February 13, 2025, which is incorporated herein by reference in its entirety.

### TECHNICAL FIELD

The subject matter disclosed generally relates to monitoring solutions for material handling and moving equipment (MHME). More particularly, the subject matter disclosed relates to systems and methods for determining incidents, for notification of incidents, and/or for reporting incidents involving the MHME with contextualization of the incidents.

### BACKGROUND

In the field of handling (manutention) of goods using material handling and moving equipment (MHME) such as, for example, forklifts, operations take place in warehouses, with handling (manutention) and moving of goods between locations may be performed using forklifts. A high number of forklifts usually need to be moved around in a conventional warehouse and particular operations to handle and displace the goods may need to be performed with the forklifts. It is therefore inevitable that incidents may occur involving forklifts, such as forklifts hitting pallet racks, columns, etc. In some cases, goods may become unusable, and even injuries may result from these incidents.

There were attempts to decrease the number of incidents for unmanned forklifts, robotized solutions, etc., but these solutions are expensive. Some solutions involve complete disruption of operations and movement of the forklift when an incident is believed to occur. However, determining whether the situation may be classified as an incident or not is difficult and time consuming for both managers and forklift operators. Stopping the operations of the forklift for periods needed to investigate the situation by a manager leads to long and unnecessary down time. There is a need for improvement in monitoring of incidents involving forklifts as well as other MHME, and overcoming these shortcomings.

### SUMMARY

According to an embodiment, there is provided an incident notification system and method configured to notify a manager on a wireless device remote from a material handling and moving equipment (MHME) of incidents in which the MHME is involved, wherein the notification is contextualized with a videoclip (also referred to herein as “video clip”) spanning over a time window around the time of the incident. According to an aspect, the notification of the incident may be provided to the manager’s device (also referred to herein as a “recipient’s device” or a “notification device”) shortly after the occurrence of the incident. In at least one embodiment, the videoclip may comprise a set of images, as well as, optionally, a sound recorded simultaneously with the images. According to an aspect, the method and system as described herein allow to differentiate between actual incidents (“detected incidents”) and “not incidents”, thus detecting actual incidents which are pertinent to MHME according to incident criteria, and generating contextualized notification following determining that the “detected incident” has occurred.

According to one aspect of the disclosed technology, there is provided a method for notifying of an incident involving the MHME, the method comprising: generating and recording a video data and corresponding timestamps therewith, by a video recording device having a local memory storage configured to store images and timestamps associated therewith, the video recording device being attached to the MHME; detecting, by an accelerometer sensor, acceleration forces with reference to each one of three axes or more than three axes, the accelerometer sensor processing the acceleration forces to determine a potential incident and potential incident timestamp and transmitting data relative to the potential incident to a server or the acceleration sensor transmitting continuously detected accelerations forces to the server; analyzing the acceleration forces within an analysis period comprising time window before and after a potential incident timestamp, based on incident criteria and determining, by the server processor, whether a detected incident has occurred and determining an incident timestamp corresponding to the moment of the detected incident, and generating a video request; upon receiving the video request by the video recording device, the video request comprising the incident timestamp from the server associated with the detected incident, transmitting, by the video recording device, to the server, an incident videoclip comprising video data recorded during a time window comprising the incident timestamp, a first pre-determined period before the detected incident and a second pre-determined period after the detected incident; and generating, by the server, a contextualized notification corresponding to the detected incident and transmitting to a manager device located remotely from the MHME, via a communication network, the contextualized notification comprising the incident videoclip providing contextualization of the incident.

According to another aspect of the disclosed technology, there is provided a system for notifying of an incident involving the MHME, the system comprising: an accelerometer sensor configured to detect and register accelerometer data comprising timestamps during a first time period; a video recording device configured to generate and register video data, and transmit, upon receiving a video request, an incident videoclip comprising images recorded during a time window; a database configured to receive and store the accelerometer data and additional sensor data; and a server configured to: receive the accelerometer data and analyze the acceleration forces based on incident criteria and determining, by the server processor, whether a detected incident has occurred and determining an incident timestamp corresponding to the moment of the detected incident, and generate and transmit the video request to the video recording device; receiving an incident videoclip comprising images recorded during a time window comprising the incident timestamp, a first pre-determined period before the detected incident and a second pre-determined period after the detected incident; and generate an incident notification corresponding to the detected incident and transmit to a manager device located remotely from the MHME, via a communication network, the incident notification comprising the incident videoclip providing contextualization of the incident.

According to a further aspect of the disclosed technology, there is provided a method configured to be executed by a system comprising: an accelerometer sensor configured to register accelerometer data comprising timestamps during a first time period; a video recording device configured to register video data, the video recording device having a database for storing the video data; a server configured to receive the sensor data and the video data; a database configured to receive and store the sensor data, the method comprising: receiving, from the accelerometer sensor installed on the MHME, the accelerometer data comprising an acceleration force and location of the MHME; determining whether an incident has occurred based on incident criteria, comprising comparing of amplitudes of acceleration forces along at least two axes registered over a time window with pre-determined amplitudes of the acceleration forces and determining an incident timestamp associated with the time of the incident; requesting based on the incident timestamp and receiving, from the video recording device, an incident videoclip comprising data within an incident period of time comprising data before, during and after the incident timestamp; and generating and transmitting an incident notification to a manager device, the notification comprising contextualization comprising the incident videoclip.

In at least one embodiment, generating and recording images and corresponding timestamps is executed in a continuous manner. In at least one embodiment, storing the images and corresponding timestamps may be executed in a continuous manner. Determining, by the server processor, whether the detected incident has occurred may further comprise analyzing additional data from additional sources. The accelerometer data may further comprise location of the MHME. Transmitting the contextualized notification may comprise transmitting an initial contextualized notification followed by transmitting a second contextualized notification, the second contextualized notification comprising the incident videoclip. Analyzing the acceleration forces may further comprise analyzing variation in time of an absolute value of acceleration force projections on each one of the axes and compare the values of the acceleration force projections with each other. Analyzing the acceleration forces may further comprise comparing acceleration force projections for different axes with each other. The method may further comprise determining whether the potential incident is the detected incident based on the duration of the peaks of the acceleration forces (for example, acceleration force projections). The MHME may be, for example, a forklift.

According to another aspect of the disclosed technology, there is provided a method of notifying of an incident involving the MHME, the method comprising: generating and recording (in at least one embodiment, in a continuous manner) images (and/or continuous video, with or without sound) and corresponding (associated) timestamps therewith, by a video recording device having a local memory storage configured to store (in at least one embodiment, in a continuous manner) images (and/or continuous video, with or without sound) and timestamps associated therewith, the video recording device being attached to the MHME; detecting, by an accelerometer sensor, acceleration forces with reference to each one of three axes or more than three axes, the accelerometer sensor processing the acceleration forces to determine a potential incident and transmitting data relative to the potential incident to a server or the acceleration sensor transmitting continuously detected accelerations forces to the server; analyzing the acceleration forces based on incident criteria and determining, by the server processor, whether an incident has occurred and an incident timestamp corresponding to the incident, and generating a video request; upon receiving the video request comprising the incident timestamp from the server associated with an incident, transmitting, by the camera, a videoclip comprising images recorded during a time window comprising the incident timestamp; and generating by the server an incident notification and transmitting to a manager device remote from the MHME, the incident notification comprising the incident videoclip providing contextualization of the incident.

According to another aspect of the disclosed technology, there is provided a method of notifying of an incident involving the MHME, the method comprising: receiving, by a server, in a continuous manner acceleration forces detected by an accelerometer mounted to a MHME, the acceleration forces along at least two axes, and timestamps corresponding to the acceleration forces and identifying time of detection of the acceleration forces; analyzing the acceleration forces detected in a time window, and determining an incident timestamp when the acceleration forces fulfill at least one incident condition; generating and transmitting, by the server, a video request to a video recording device mounted to the MHME, the video recording device recording in a continuous manner images and corresponding timestamps identifying time of recording of the images; receiving, by the server from the video recording device, an incident videoclip comprising video images spanning over an incident time period comprising the determined incident timestamp therein; generating and transmitting a notification of the detected incident to a manager device remote from the MHME, wherein the notification comprises the incident videoclip.

According to another aspect of the disclosed technology, there is provided a method configured to be executed by a system comprising: an accelerometer sensor configured to register accelerometer data comprising timestamps during a first time period; a camera configured to register video data, the camera having a camera database for storing the video data; a server configured to receive the sensor data and the video data; a database configured to receive and store the sensor data, the method comprising: receiving, from the accelerometer sensor installed on a MHME such as, for example, forklifts, the accelerometer data comprising an acceleration force and optionally location of the MHME; determining whether an incident has occurred based on incident criteria, comprising comparing of amplitudes of acceleration forces along at least two axes registered over a time window with pre-determined amplitudes of the acceleration forces and determining an incident timestamp associated with the time of the incident; requesting based on the incident timestamp and receiving, from the camera, an incident videoclip comprising data within an incident period of time comprising data before, during and after the incident timestamp; and generating and transmitting a notification of the incident to a manager device, the notification comprising contextualization comprising the incident videoclip.

According to another aspect of the disclosed technology, a system and method for generating a notification of an incident involving the MHME and providing the notification to a recipient’s device are provided. In at least one embodiment, the system comprises the MHME with a camera, mounted thereto, configured to generate images and timestamps associated therewith (for example, in a continuous manner); an accelerometer sensor mounted to the MHME for detecting accelerations forces along three axes or more, with the accelerometer sensor transmitting registered accelerations forces to a server; and a server detecting incidents based on the acceleration forces received and incident criteria. Upon detecting of an incident, the server requests and receives a videoclip of the incident from the camera, and generates and transmits a notification of the incident to the manager’s device, the notification comprising the videoclip and additional information, helping the manager to determine whether the incident is worth investigating without a downtime in the operation of the MHME.

According to another aspect of the disclosed technology, the method comprises generating and recording a video data with corresponding timestamps by a video recording device; detecting acceleration forces with reference to each one of at least three axes, an accelerometer sensor processing the acceleration forces to determine a potential incident and corresponding timestamp and transmitting data relative to the potential incident to a server or the acceleration sensor transmitting continuously detected accelerations forces to the server; analyzing the acceleration forces within an analysis period comprising time window before and after a potential incident timestamp based on incident criteria and determining whether a detected incident has occurred; requesting and transmitting an incident videoclip; and generating a contextualized notification corresponding to the detected incident and transmitting to a manager device located remotely from the MHME.

Features and advantages of the subject matter hereof will become more apparent in light of the following detailed description of selected embodiments, as illustrated in the accompanying figures. As will be realized, the subject matter disclosed herein is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view of a forklift in accordance with an embodiment;

FIG. 2 is a perspective view of a manager with a wireless device adapted to receive an incident notification in accordance with an embodiment;

FIG. 3 is a schematic block diagram illustrating components of a system configured to monitor incidents and generate textualized notifications of incidents in accordance with an embodiment;

FIG. 4 is a schematic block diagram of a server of a system configured to monitor incidents and generate textualized notifications of incidents in accordance with an embodiment;

FIG. 5 is a perspective view of a moving forklift when no incident is associated therewith;

FIG. 6 is a perspective view of a moving forklift passing on cracked floor, such operation not being considered an incident in accordance with an embodiment;

FIG. 7 is a perspective view of a forklift immediately after hitting a column of a warehouse, such situation being considered an incident in accordance with an embodiment;

FIG. 8 is a graph illustrating acceleration forces registered by an accelerometer sensor before, at the time of, and after occurrence of an incident, wherein the acceleration forces are illustrated for three axes in accordance with an embodiment;

FIG. 9 depicts processing and packet transmission during the execution of a method in accordance with at least one embodiment by components of the system in accordance with at least one embodiment, wherein the processing and packet transmission may be associated with normal operation, detected incidents, and declared incidents;

FIG. 10 illustrates a flowchart of the method for notifying of an incident involving a material handling and moving equipment, in accordance with at least one embodiment of the present disclosure; and

FIG. 11 schematically illustrates analysis period with reference to a potential incident timestamp, in accordance with at least one embodiment of the present disclosure.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term "or" should generally be understood to mean "and/or" and so forth.

In the following description, it is understood that terms such as "first", "second", "top", "bottom", "above", "below", and the like, are words of convenience and are not to be construed as limiting terms.

The terms "top", “up”, “upper”, "bottom", “lower”, “down”, “vertical”, “horizontal”, “interior” and “exterior” and the like are intended to be construed in their normal meaning in relation with normal operation of a forklift.

It will be noted that throughout the appended drawings, like features are identified by like reference numerals.

The term “transmitting” refers to a component of the system communicating data, in the form of a data packet, to a second component of the system.

The expression “transmitting continuously” refers to a component of the system transmitting to a second component of the system a series of packets one after another, without the transmission of at least some of the packets being specifically subject of a request for the packets from the second component of the system. Accordingly, the expression “transmitting continuously” refers to situations wherein a first component, after receiving a request from another component, to start transmitting one packet after another until a condition occurs, such as the end of operation of the system, or a request for the end of the continuous transmission. It is to be noted that “transmitting continuously” may involve, without departing from the definition, the second component transmitting, e.g., requested data packets to one component of the system between transmission of data packets subject of the continuous transmission.

The expression “notification” refers to a signal of data packet sent to a component without request, and without mandatorily requiring a response from the component.

The expressions “context” and “contextualization” refer to enrichment of information providing a component or the system, for example for presentation to a person, an enriched view of an event (enriched data related to the event), allowing to determine the importance, seriousness, etc. of the event and to determine actions to initiate in view of the context.

In the context of the present specification, the term “routine” refers to a subset of the computer executable program instructions of an application that is executable by the server processor to perform the functions explained herein in association with the various routines. It should be understood that routines are illustrated schematically herein as separate entities for ease of explanation of the processes executed by the application. It is contemplated that some or all of the routines may be implemented as one or more combined routines.

A material handling and moving equipment (MHME), also referred to herein as a material handling equipment (MHE) or a “goods moving vehicle” or a “goods moving and handling vehicle”, refers to the industrial equipment (or an industrial goods moving equipment) that moves, lifts, manipulates, positions and places material, goods or loads. The MHME may be, for example, a forklift, a loader, an electric jigger, pallet trucks, container handler or any other industrial equipment configured to handle and move, lift, manipulate, position and place material, goods or loads. The MHME is configured to operate in industrial and off-road environments. Conditions of operations of the MHME in an industrial environment is different from the conditions of operation of a conventional road vehicle, such as a car or a truck on a conventional road (for example, a street or a highway). The technology as described herein is adapted for the industrial equipment operating in the industrial environment. Such an industrial environment may be characterised, for example, by an uneven floor, floor having cracks, and/or having multiple obstacles located on the floor and/or above the floor. Although the technology as described herein may be used in road conditions, the system and method as described herein is relevant to the environments where the MHME operates, which is referred to herein as the “industrial environment”.

In the context of the present disclosure, the term “incident” refers to the occurrence of a random event worth reporting and/or investigating in accordance with conditions associated therewith. An example of an incident is the MHME hitting an object. The incident as referred to herein occurs in an industrial environment which may be characterized, for example, by the uneven floor and multiple obstacles. Due to the industrial environment, the system and method as described herein take more factors into consideration in order to detect and/or declare an incident.

The expression “potential incident” refers to any unusual deviation from a normal movement and other behavior of the MHME within an industrial environment. The “potential incident” may comprise, for example, a “potential impact”.

The expression “detected incident” refers to the potential incident that is detected and classified as being “detected incident” by the system as described herein. A potential incident which is not classified as the “detected incident” by the system as described herein is a minor unusual deviation from normal movement and other behavior of the MHME within the industrial environment.

The expression “declared incident” refers to a potential incident that is declared by a person.

The system and method as described herein may be used when an operator operates (manipulates) the MHME that may cause or result in a collision or another incident that may cause damage or loss, and wherein a manager or another person or entity needs to analyse the circumstances of the incident, after the incident has happened, to determine whether there was any fault of the operator or the operating environment and provide any other conclusions.

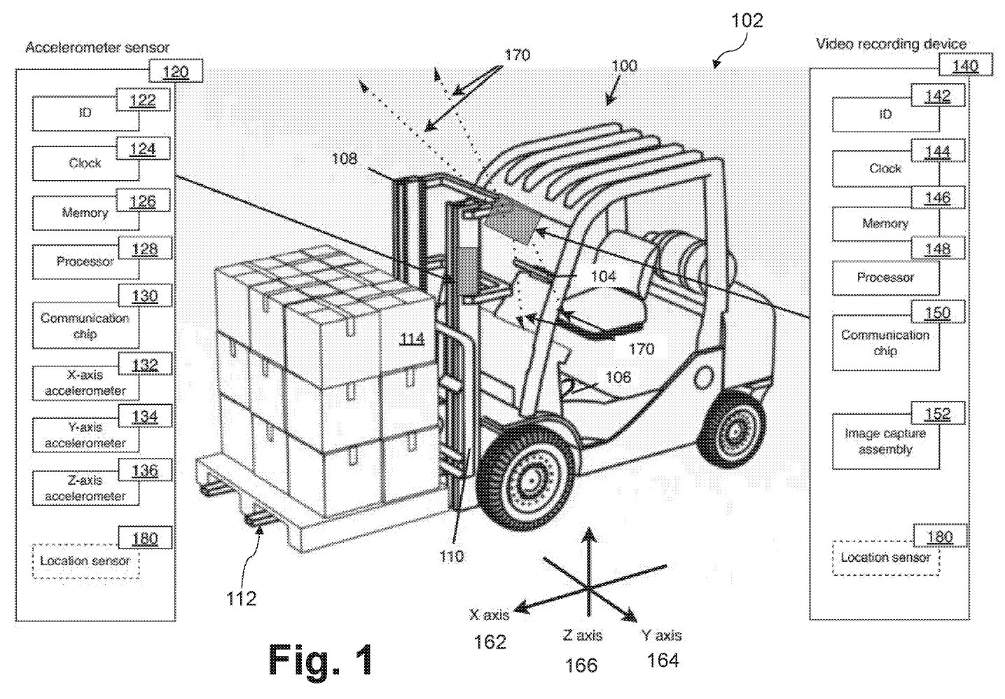

Although the description below and drawings are provided with reference to a forklift 100 illustrated in FIG. 1, it is contemplated that the system and method as described herein may be provided for and executed by other MHME 100.

The system and method as described herein provide advantages for the MHME which operate in the industrial environment. In a conventional road environment with convention road vehicles (cars, trucks, etc.), an additional analysis of accelerometer data as described herein and, more importantly, any additional analysis of additional data is less relevant because the forces experienced during a collision involving conventional road vehicles are much stronger than the forces experienced during a conventional driving using the conventional road vehicles. While for the conventional road vehicles, the forces experienced at the impact are much stronger than regular driving forces, for MHME and the industrial environment, the forces experienced at the impact/collision are similar to and sometimes even weaker than regular operating forces.

However, in industrial environments with MHME, a simple analysis of the forces experienced at the time of a collision is not enough to identify true incidents such as collisions or impacts (referred to herein as “detected incidents”) of the MHME, because the MHME’s normal (usual, ordinary) operation often triggers forces that are equal to or even stronger than forces experienced during a collision. The industrial environment as described herein is a particular environment where small collisions may be important. Often the MHME experiences forces that do not need to be reported as being collision-related (in other terms, when the potential incident should not be classified as and reported as the detected incident). The system as described herein performs an additional analysis of the MHME behavior before, during and after the incident. In other words, the method and system as described herein considers the data and behaviors of the current MHME data using the data leading up to potential incident, during the potential incident and after the potential incident. This additional analysis allows the system to understand the current behavior of the MHME and determine whether the potential incident may be classified as the detected incident.

The analysis may comprise analysing the accelerometer data at the time of the potential incident, analysing the equipment behaviour and data collected preceding the potential incident and following the potential incident, as well as the analysis of the environment context (analysis of the controlled zones, for example). The system as described herein analyses a plurality of characteristics with reference to various factors in order to determine that the potential incident may be considered as (classified as) the detected incident (for example, a detected collision).

Referring now to the drawings, and more particularly to FIG. 1, an operating environment of the MHME such as, for example, a forklift 100, is an industrial environment such as, for example, a warehouse, has goods moved therein, wherein monitored forklifts 100 are used for such operations. A monitored forklift 100 illustrated in FIG. 1 in accordance with at least one embodiment, comprises an accelerometer sensor 120 and a video recording device 140, both adapted to receive and transmit data over a network 300 (also referred to herein as a “communication network 300”).

According to embodiments, the operating environment as referred to herein is an industrial environment and may comprise other environments where the MHME operate (are operated), comprising but not limited to shops, warehouses, inside beds of trucks transporting goods, facility, yard, port, warehouse, construction site, or industrial setting, the environment around the warehouse such as driveways, alone or in combination. For example, a loader may operate inside and outside of the warehouse to charge and discharge the load. According to embodiments, goods may be manipulated and/or moved by the MHME, and in alternative situations other MHME may be the object of the solution disclosed herein.

MHME are not approved for operation on public roads, but rather in private, industrial and controlled sites. The MHME is built to respect industrial standards, the design of the MHME does not comply with road vehicle standards. While a conventional road vehicle must respect road vehicle standards, MHME is not subject to road registration. The primary function of the MHME is material handling, such as, for example, lifting, moving, and/or positioning. The speed and safety systems and characteristics of the MHME are industrial rather than road rated, and MHME falls under occupational health and safety regulations, not the Highway / Road Traffic Code.

The accelerometer sensor 120 is configured to register acceleration forces undergone along three axes or more than three axes. For example, the three axes may be, as illustrated in FIG. 1, the x axis 162 corresponding to the longitudinal axis of the forklift 100; the y axis 164 corresponding to the transversal axis of the forklift 100; and the z axis 166 corresponding to a vertical axis. As illustrated in FIG. 1, the accelerometer sensor 120 has an accelerometer ID 122 allowing to identify the accelerometer sensor 120 and the data transmitted by the accelerometer sensor 120, and comprises an accelerometer internal clock 124, an accelerometer memory 126 (or memories or memory storage(s)) adapted to store firmware, software comprising routines and other instructions, and data, an accelerometer processor 128, and an accelerometer communication chip 130 allowing to transmit data packets over the network 300. To detect and register acceleration forces undergone, the accelerometer sensor 120 comprises an X-axis accelerometer 132, a Y-axis accelerometer 134, and a Z-axis accelerometer 136, with these accelerometers operating independently and in parallel with each other.

The accelerometer sensor 120, as well as other sensors described herein (such as, for example, the additional sensors described herein) may be internal sensors which are integrated into/with (for example, built-in) the MHME 100 and/or may be external sensors attached to (for example, removably) to the MHME 100.

The video recording device 140 (which may be also referred to as “camera 140”) has a video recording device ID 142 and comprises a video recording internal clock 144, a video recording memory 146 or memories configured to store firmware, software comprising routines and other instructions and data, a video recording processor 148, and a video recording communication chip 150. According to an embodiment, the video recording memory 146 is a hardware which is a memory configured to store video recording firmware and instructions for execution steps of the method as described herein by the processor 148, and a removable expandable memory configured to store videos as will be explained hereinafter, such as, for example, a flash memory card.

The video recording device 140 further comprises an image capture assembly 152, which comprises components involved in image capture, such as, for example, a lens, image capture chips, image processing chips, etc.

According to at least one embodiment, the video recording device 140 alone using at least one panoramic lens or at least one panomorph lens, or a combination of lenses, or through a combination of video recording devices 140, is configured to have a wide field of view as illustrated on FIG. 1 (the field of view being identified in FIG. 1 with arrows 170 and is referred to herein as the “field of view 170”), ideally covering the controls of the forklift 100 such as the steering wheel 104, and optionally pedals 106. For example, the lenses may provide approximately 360 degrees of view. Preferably, the field of view 170 of the video recording device(s) 140 is set to cover the mast 108, the carriage 110, and the forks 112 of the forklift 100, as the goods 114 transported by the forklift 100.

According to embodiments, the field of view 170 may be increased, e.g., using a plurality of video recording devices and/or lens that may be placed in different locations and/or oriented differently. According to embodiments, the video recording device 140 may be configured to record sound as well as images (sequence of images) of the video. For example, the sound may be recorded together with a sequence of images and thus provide a video recording. Alternatively, the sound may be recorded in parallel with the images and there be synchronized with the images.

The system 102 as described herein may be configured to record and provide on demand, as described below, a sound history of the incident, that may provide additional context to the incident. In at least one embodiment, the accelerometer sensor 120 and the video recording device 140 are mounted on or otherwise attached to the forklift 100. For example, the accelerometer sensor 120 may be attached using a magnet that may be installed in the accelerometer sensor 120 and that can attach to a metal surface of the forklift 100.For example, the accelerometer sensor 120 and the video recording device 140 may have casing and a mounting element allowing to mount or otherwise attach them to the forklift 100, and a power source. The accelerometer sensor 120 and the video recording device 140 may comprise additional components necessary for their operability. According to embodiments, the accelerometer sensor 120 and/or the video recording device 140 have internal batteries powering them, with these components being connected to the forklift 100 for recharging the batteries and/or maintaining the charges of the batteries.

Furthermore, the accelerometer sensor 120 and/or the video recording device 140, and/or an additional component of the system attached to the forklift 100, may comprise a location sensor 180 configured to detect and register position of the forklift 100. To detect and register a position (a location) of the forklift 100, the location sensor 180 may use, for example, a global positioning system (GPS), local position detection sensors installed, for example, in the warehouse and/or detectable components, radio frequency identification (RFIDs), Bluetooth^{TM} Low Energy (BLE) tags, etc. The location sensor 180 may also have magnetic position or orientation sensors, compasses, load or mast position sensors.

It is worth mentioning that as one skilled in the art wound consider variation may be realization in the physical combination of components, duplication and/or division of components without affecting the way the technology operates. Thus, throughout the description provided herein, alternative combinations and/or components configured to perform the same function are also contemplated.

For instance, according to an embodiment, both the accelerometer sensor 120 and the video recording device 140 register accelerations forces, with the acceleration forces of both components being used to detect incidents.

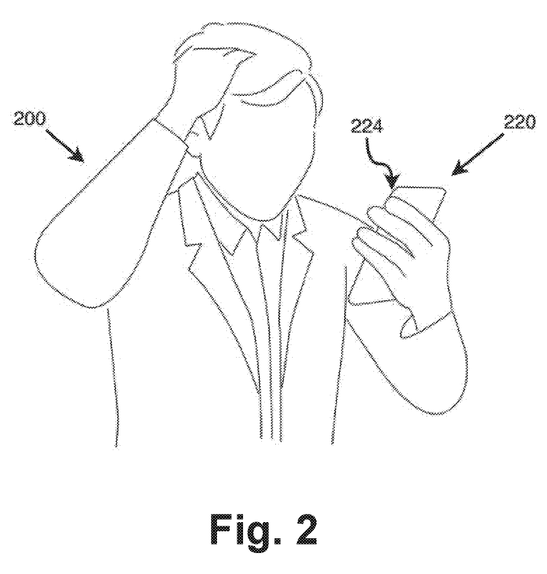

Referring to FIG. 2, the operation of the warehouse and other industrial environment involves drivers driving the forklifts 100 and at least one manager 200 (or another person responsible of product quality, incidents, or other aspects of the operation) being in charge of investigating incidents occurred during the operation. The manager 200 is equipped with a notification device 220 (also referred to herein as a “manager’s device” or a “manager device” or “recipient’s device”) that may be remote (in other words, may be located remotely) from the forklift 100 and communicate wirelessly with other components of the system 102 via the network 300. In accordance with the present description, the notification device 220 is a mobile processing device having communication and display capability. In at least one embodiment, the notification device 220 has a notification device processor 222 and a notification device display 224. For example, the notification device 220 may be a laptop, a smartphone, an iPad, a tablet or a handheld electronic device.

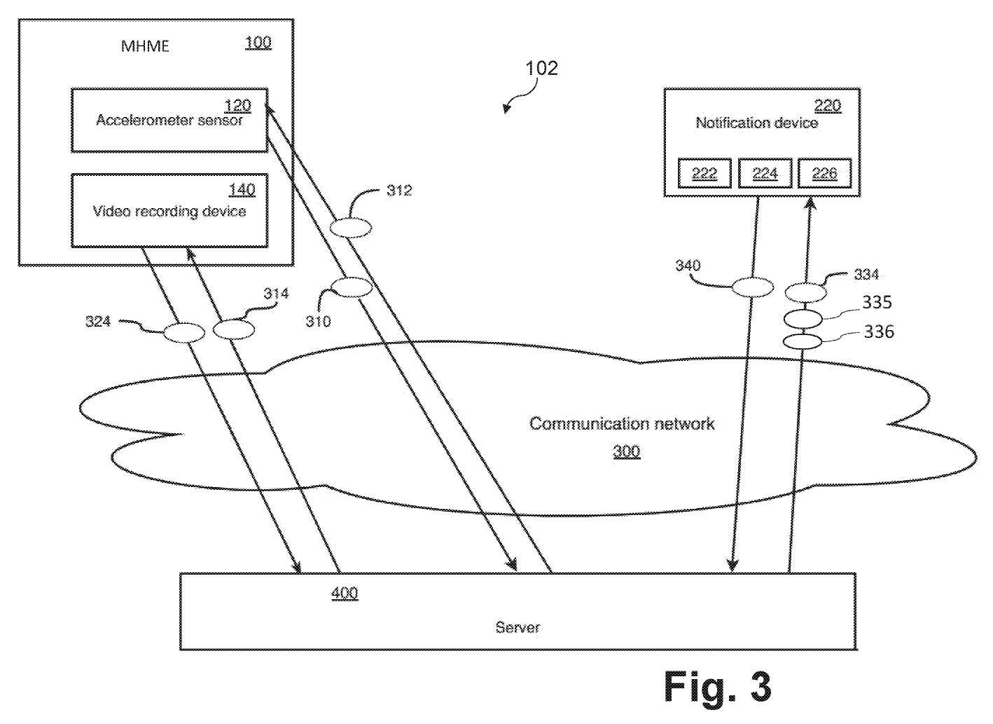

Referring to FIG. 3, the system 102 for notifying of an incident involving a MHME comprises one or more monitored MHME 100 (illustrated as forklifts 100) comprising the accelerometer sensor 120 and the video recording device 140, the notification device 220 accessible by a manager 200, and a server 400. The MHME 100 (such as, for example, forklift 100), the notification device 220 and the server 400 communicate with each other via a wireless communication network 300 (also referred to herein as the “network”).

In at least one embodiment, the wireless communication network 300 of the present description may comprise a plurality of communication networks with bridges in-between allowing transfer of data in-between. Examples of such communication networks that may be part of the wireless communication network 300 may comprise a Wi-Fi network, an LTE communication network, Bluetooth^{TM}, and the internet to list a few.

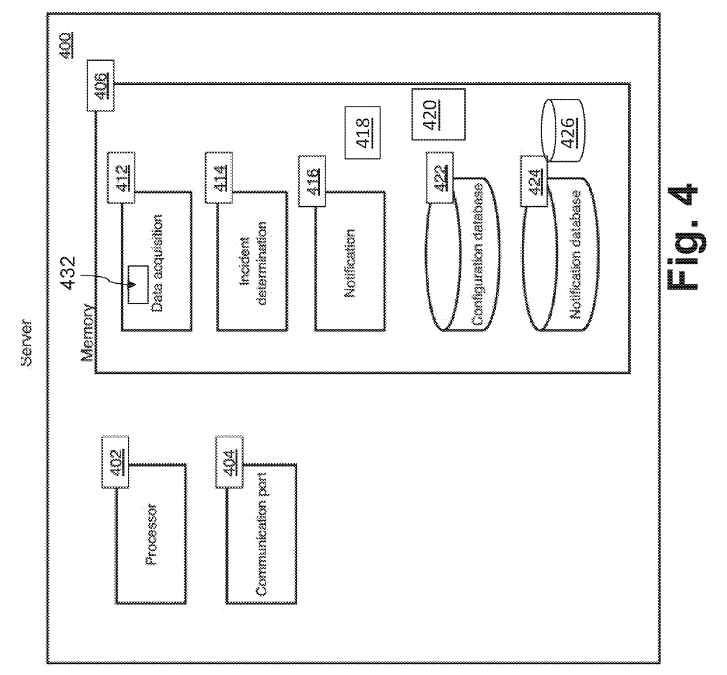

Referring also to FIG. 4, the server 400 is configured to exchange data (communicate) with the accelerometer sensor 120 and the video recording device 140 of the MHME 100 (forklift 100), and the notification device 220 of the manager 200 to perform incident detection and incident notification.

It is to be noted that although the singular term “server” is used for the present description, components and operations of the server may be distributed over a plurality of components, and may be spread geographically, such as, for example, in cloud computing, such as, for example, in cloud computing provided by AZURE™ from Microsoft™.

Back to FIG. 4, the server 400 comprises a processor 402, a server communication port 404, a server memory 406 storing a data acquisition routine 412, an incident determination routine 414, and a notification routine 416 (also referred to herein as an “incident notification routine 416”). The server 400 as described herein is configured to execute an application which executes or otherwise has access to the routines as described herein. The memory 406, which is a computer readable medium (computer readable memory), is further configured to store databases, for instance a configuration database 422, a notification database 424, accelerometer-acquired database 426.

It is worth noting that according to embodiments, more information may be stored on the server 400, as the size of the archive of information accessible on the server 400 may vary.

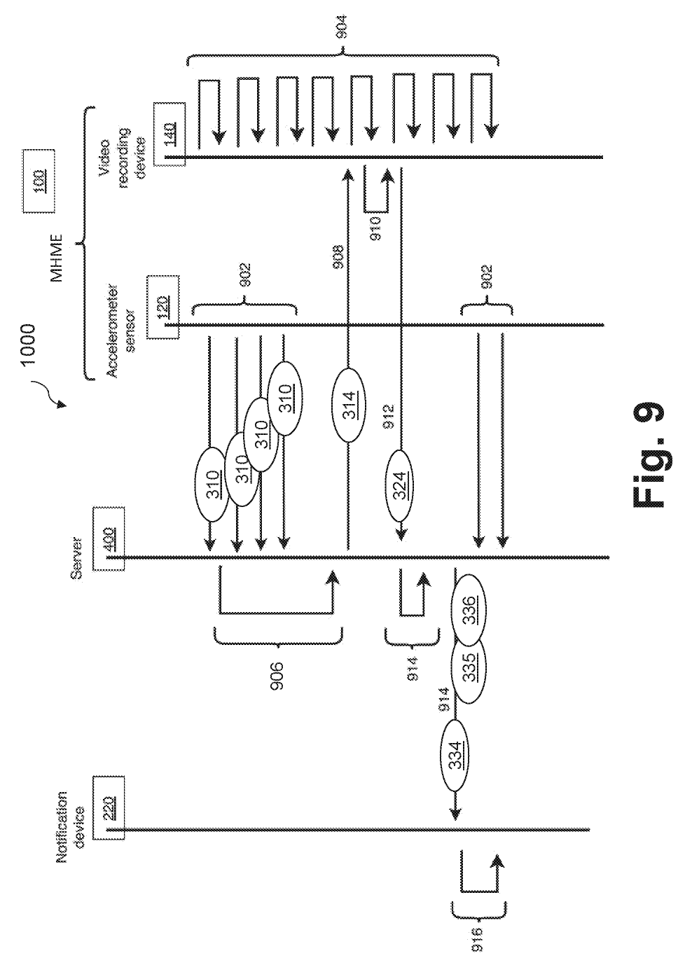

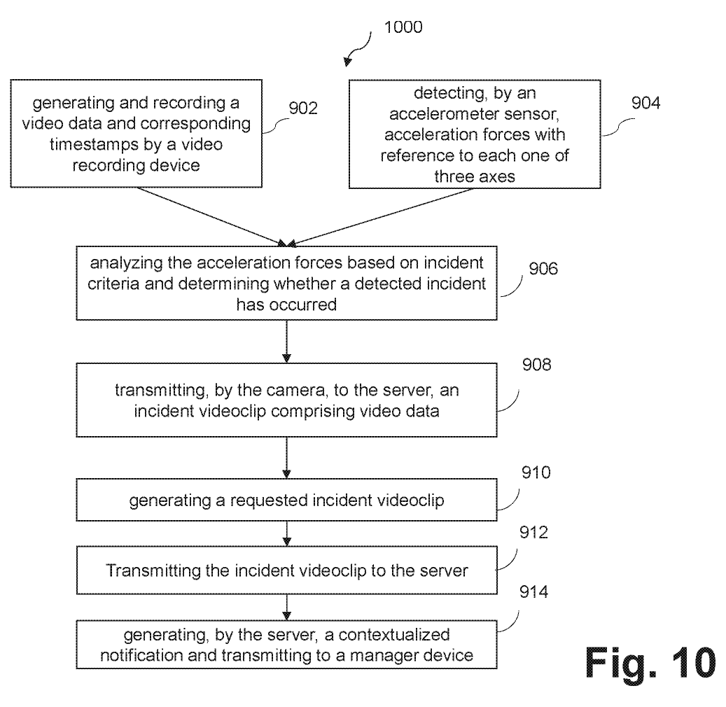

Referring to FIGS. 1, 8, 9, 10, the method 1000 of operation of the system 102 comprises many steps. Although the operation below is described with reference to the forklift 100 illustrated in FIG. 1, it is contemplated that the system 102 and method 1000 as described herein may be provided for and executed by other MHME 100 as described above. FIG. 9 illustrates processing and packet transmission between the elements of the system 102, and FIG. 10 illustrates a flowchart of the method for notifying of an incident involving an MHME. The method 1000 is described with reference to FIGS. 1-10, and FIG. 11.

At step 902 of the method 1000 as described herein, during the operation of the MHME 100 (forklift 100 in FIG. 1), the accelerometer sensor 120 measures and registers acceleration forces and pre-processes the acceleration forces to determine potential incidents. In parallel, the accelerometer sensor 120 generates and transmits, for example, continuously, data (comprising accelerometer data packets 300, which comprises forces measured by the accelerometer) related to the operation of the MHME 100 to the server 400, such as, e.g., motion data providing a current operation status of the MHME 100. The motion data may comprise the equipment behavior information whether the MHME 100 moves or does not move, and, in some embodiments, data regarding sudden (abrupt), rapid or unusual accelerations and/or sudden (abrupt), rapid or unusual braking. In some embodiments, the accelerometer sensor 120 may generate and transmit to the server 400 data regarding the speed and/or direction of the MHME 100, whether the accelerometer sensor 120 is plugged and received current from the external source, and/or GPS data, and/or other sensor’s data, for example, related to positioning of the MHME 100 in the operating environment, such as, for example, using a beacon technology. The motion data may also be received from one or more gyroscopic sensors, tilt sensors, additional speed sensors.

The accelerometer internal clock 124 is synchronized with the server 400 and the accelerometer sensor 120 may register, for example, thousands of datapoints of the measured accelerometer force per second.

During pre-processing, the accelerometer processor 128 analyses data collected, such as, for example, acceleration and braking information, and determines whether a potential incident has occurred and determined a potential incident timestamp and optionally flags the related data that there was a potential incident.

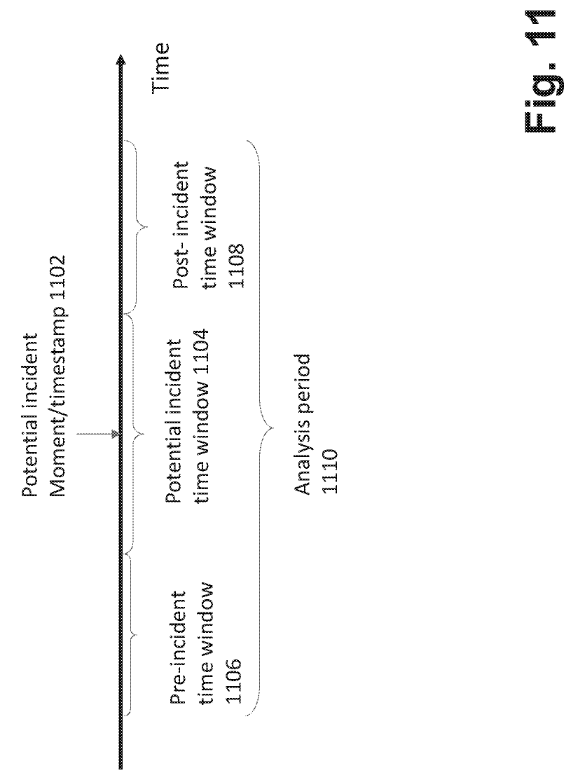

After the potential incident is determined by the accelerometer processor 128 of the accelerometer sensor 120 (in other terms, after the accelerometer processor 128 determines that the potential incident has occurred at a potential incident moment 1102 schematically illustrated in FIG. 11), the accelerometer sensor 120 transmits the accelerometer data packets 310 to the server 400. The accelerometer data packets 310 comprise accelerometer force along each axis and corresponding timestamps, where the accelerometer force was collected before and after the potential incident moment which is characterized by a potential incident timestamp (in other words, within a pre-determined potential incident time period/window 1104) and additional sensor data and/or peripheral data. The accelerometer data packets 310 transmitted to the server 400, comprise also the accelerometer ID 122 of the accelerometer sensor 120. The accelerometer data packets 310 may comprise additional information allowing the server 400 to validate and/or determine whether the potential incident (as determined by the accelerometer processor 128) respects the criteria of the detected incident, and therefore whether the manager 200 needs to be notified. The accelerometer data packets, transmitted from the accelerometer sensor 120 to the server 400, may comprise, for example, equipment behavior data, such as motion (on/off) data and driving data (abrupt acceleration and/or abrupt braking, etc.). In some embodiments, the accelerometer data packets 310 may also comprise speed data, MHME movement direction data, GPS data, sensor power data, etc. The accelerometer data packets 310 may comprise data from external sensors and/or internal sensors of the MHME.

Alternatively, the server 400 may retrieve such data (speed data, MHME movement direction data, GPS data, sensor power data, etc.) from the information already received from the accelerometer sensor 120 and stored in the accelerometer-acquired database 426 earlier, for example using the potential incident timestamp 1102.

The server 400 then determines (validates) whether the potential incident is a detected incident. In other words, whether the potential incident is more than an unusual deviation from a normal movement and other behavior of the MHME 100 within the industrial environment and whether such potential incident may be classified as the detected incident. In at least one embodiment, the server processor 402 of the server 400 takes into consideration acceleration forces during a potential incident time window 1104 (which is determined by the processor 402 based on the pre-determined time period around the potential incident moment 1102), as well as other data registered, processed and/or transmitted before and after the potential incident time window 1104 to improve the determination and validation of the detected incident. The processor 402 of the server 400 takes into account the acceleration forces (and their projections to at least one axis) for the time periods before and after the pre-determined time window, that is during the pre-incident time window 1106 and post-incident time window 1108, as illustrated in FIG. 11.

In industrial material handling environments, acceleration magnitude alone is insufficient to determine whether a detected mechanical disturbance corresponds to a collision. The MHME routinely experiences forces during normal operation that are equal to or greater than those generated by minor impacts, such as, for example, pallet engagement, braking, floor discontinuities, docking transitions, and other operational maneuvers. Accordingly, the server processor 402 classifies the incident not only based on threshold value(s) of sensed force(s), but also using the additional sensor data received from the additional sensors as described herein. After identifying the potential incident, the system 102 performs contextual behavioral analysis of the MHME by evaluating operational parameters temporally associated with a disturbance within a surrounding operational interval also referred to herein as the “analysis period 1110”. Such surrounding operational interval comprises the activity that has occurred and was measured before and after the timestamp related to that disturbance (potential incident timestamp). The surrounding operational interval (analysis period 1110) is selected to capture both pre-disturbance operating behavior and post-disturbance response behavior of the equipment, allowing the system 102 to determine whether the disturbance identified as the potential incident is consistent with normal operation or indicative of unintended external to MHME contact. The surrounding operational interval (analysis period 1110) may span multiple seconds of operation and may vary depending on equipment characteristics, configuration, or operating environment of the MHME, and is not limited to a fixed duration.

The processor 402 executes a contextual behavioral analysis which determines whether the mechanical disturbance occurred and classified as the potential incident is consistent with expected operational behavior of the MHME. In at least one embodiment, the processor 402 evaluates one or more non-limiting categories of operational indicators, individually or in combination, comprising motion characteristics, temporal disturbance characteristics, and equipment operational state. Such operational indicators may be, for example: acceleration characteristics along one or more axes, relative changes between acceleration characteristics along different axes (for example, two, three, or more axes), rate of change of acceleration, duration or persistence of force, direction changes, start-stop motion behavior, braking behavior, oscillatory or repetitive patterns, and continuity of motion before and after the disturbance (potential incident); vehicle operating conditions such as speed, travel direction, and/or steering behavior; operational state indicators obtainable directly and/or indirectly from the equipment, comprising lifting activity, mast and/or fork movement, load interaction, and/or other equipment actuation; environmental interaction indicators such as, for example, traversal of facility features or recurring operational structures. Historical operational data associated with the MHME 100 may also be considered by the system 102 to distinguish routine maneuvers of the MHME 100 from anomalous events.

Based on such an evaluation by the contextual behavioral analysis, the processor 402 classifies the disturbance identified earlier as a potential incident as either a detected incident (which corresponds to a collision event) or a non-collision operational event, and only following the classification of the incident as the detected incident (a collision event, the processor 402 generates the detected incident timestamp and the corresponding contextualized notification. The particular parameters, weighting, and computational techniques that may be used to perform the contextual behavioral analysis may vary. For example, the contextual behavioral analysis may be implemented using rule-based processing, statistical evaluation, pattern recognition, machine learning models, or other analytical techniques, provided that classification is based on behavioral consistency of the disturbance with operation of the MHME rather than solely on magnitude of sensed (measured) force.

The processing of the method 1000 as described herein is distributed over the server processor 402 and the sensor processor 128, and the amount of data exchanged between the server 400 and the sensor 120 may be limited. In at least one embodiment, the accelerometer sensor 120 communicates data to the server 400 if the communication network is available. This communication may occur repeatedly and every time communication triggers are met, when the communication network is available.

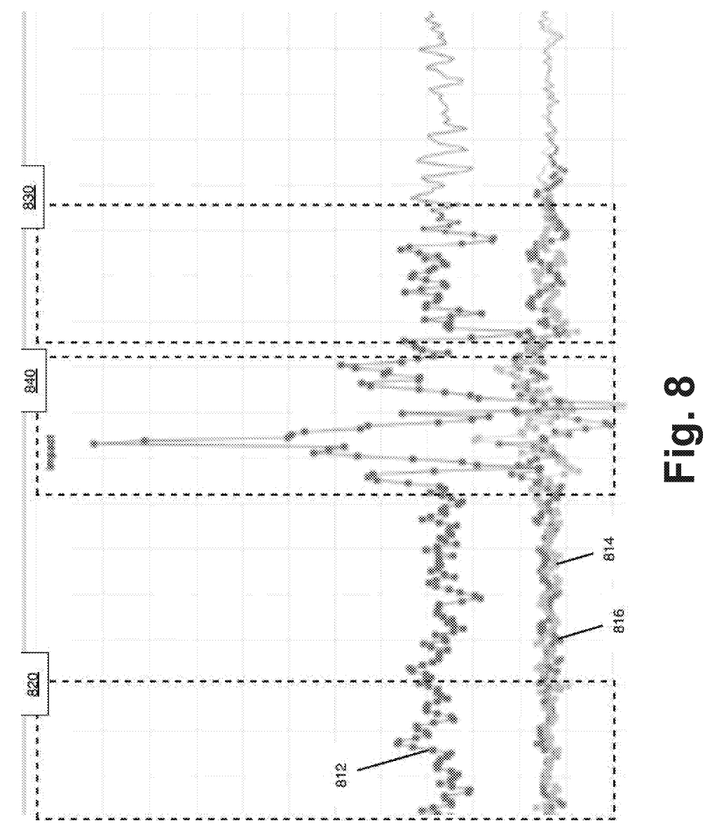

Alternatively, at step 902, during operation of the MHME 100, the accelerometer sensor 120 measures acceleration forces, and generates and transmits, for example continuously, accelerometer data packets 310 (FIG. 3) to the server 400. The accelerometer data packets 310 comprise registered accelerations forces 812, 814, 816 (FIG. 8) along the X axis 162, the Y axis 164, and the Z axis 168 (FIG. 1). In at least one embodiment, the accelerometer data packets 310 also comprise the accelerometer ID 122 of the accelerometer sensor 120 and timestamps corresponding to the transmitted accelerometer force along the axes. The timestamps are generated by the accelerometer internal clock 124 which is synchronized with the server 400, and the accelerometer sensor 120 may register, for example, thousands of datapoints of the measured accelerometer force per second.

At step 904, in parallel to step 902, the video recording device 140 generates and records, for example continuously, and may continuously store images/videos of the operation of the MHME 100 in video recording memory 146 with timestamps associated therewith generated by the video recording internal clock 144 of the video recording device 140.

At step 906, as the server 400 receives the accelerometer data packets 310, the server processor 402 of the server 400 executes the data acquisition routine 412 to extract from the accelerometer data packages 310 accelerometer data and the extracted record accelerometer data to generate a history of the registered acceleration forces undergone by the MHME 100. Data available through sensors and other peripherals, both internal and external, may also be taken into consideration during step 906. Furthermore, the server processor 402 executes the incident determination routine 414 that determines whether a registered acceleration-forces history at any time, in view of the data received continuously, fulfills conditions of a detected incident.

When the potential incident is detected as being the “detected incident”, and therefore classified as such by the server processor 402, the server processor 402 associates a detected-incident timestamp with such detected incident. The incident determination routine 414 operates as discussed in more detail hereinafter. The conditions for a detected incident may comprise, but are not limited to, a pre-determined (specified) operating behaviour preceding the potential impact, pre-determined (specified) acceleration force thresholds being met during the potential impact and pre-determined (specified) operating behaviour following the potential impact. The operating behaviour may be identified by accelerometer forces achieved by the MHME 100 and/or other readings of the data. In some embodiments, additional conditions for categorization may be applied.

At step 906, the server processor 402 analyzes the data received before, during, and after the potential incident. This analysis takes into account not only the accelerometer forces measured and registered before, during and after the potential incident moment/timestamp 1102 (FIG. 11), but also the additional data measured by, registered by, and received from the additional sensors as described herein, and then categorizes the incident as an actual detected incident or as normal operation. This step is executed between receiving the sensor data in accelerometer data packages 310 that indicate higher than pre-determined level of accelerometer force measured, and before sending the video request 314 to the video recording device 140 (FIG. 9).

The additional data (also referred to herein as the “additional sensor data”) may comprise, for example, data measured and registered by, and received from the additional sensors such as, for example, other MHME onboard sensors, MHME control systems, positioning systems, proximity and collision detection sensors, vision and video analytics, telemetry and internet of things (IoT) systems, passive environmental detection systems. The additional sensors may be passive infrared (PIR) sensors, microwave sensors, ultrasound sensors, additional auditory sensors such as, for example, additional microphones and glass break sensors, temperature sensors, air quality sensors, ambient light sensors, proximity sensors, barometers, hydraulic pressure sensors and other pressure sensors, force or load sensors, weight sensors, radar sensors, and light detecting and ranging (LiDAR) sensors. The additional sensors may further comprise one or more emitting components, such as radar emitters, laser emitters, visible light sources, infrared emitters, ultraviolet light sources, microwave emitters, or other emission sources for use with corresponding sensing modalities. The additional sensors may comprise motor current sensors, encoder sensors, inertial measurement units (IMUs), vibration sensors, thermal sensors, steering angle sensors, braking sensors, or other sensors configured to monitor operational characteristics, movement, orientation, load state, and/or mechanical condition of the equipment. The additional sensors may comprise radio frequency sensors or communication devices, comprising Bluetooth, Wi-Fi, near-field communication (NFC), cellular, ultra-wideband (UWB), or other RF-based sensors or transceivers, which may receive, transmit, or exchange data with external devices, infrastructure, or systems. The additional sensors may be internal sensors integrated into/with the MHME and/or external sensors attached to (for example, removably) to the MHME.

At step 908, after the detected incident is identified (in other terms, after the potential incident is identified/classified as being the detected incident) and the detected-incident timestamp has been associated therewith, the server processor 402 executes a video data acquisition routine 432 (which may be, for example, part of the data acquisition routine 412 illustrated in FIG. 4) in order to retrieve an incident-related videoclip, or in other words a time-sorted set of images (and corresponding sound, in some embodiments), from the video recording device 140 of the MHME 100. For contextualization, the incident-related videoclip covers a detected-incident time period (also referred to herein as “video recording time window”) that spans from a moment sometime before a detected-incident timestamp to a moment sometime after the detected-incident timestamp. In at least one embodiment, referring to FIG. 11, the videoclip may start at the start (beginning) of the pre-incident time window 1106 and finish at the end of the post-incident time window 1108, and may span during the analysis period 1110 illustrated in FIG. 11. In some embodiments, the video recording time window of the video clip requested from the video recording device 140 may be different from (longer or shorter than) the analysis period 1110 used by the processor 402 to determine whether the potential incident is the detected incident.

Referring now also to FIGS. 3 and 9, the server 400 transmits a request packet 314 (also referred to herein as a “video request 314”) to the video recording device(s) 140 associated with the forklift 100 for an incident videoclip associated with the detected-incident timestamp. For example, such video requests 314 may comprise the detected-incident timestamp and, optionally, a duration of the detected-incident time period. According to embodiments, the video request packet 314 may alternatively or additionally comprise a videoclip beginning timestamp and a videoclip end timestamp, and/or video duration information (e.g. the video recording time window), and, in some embodiments, other pertinent data.

At step 910, upon reception of the video request 314, the video recording processor 148 of the video recording device 140 retrieves from the video recording memory 146 video data (comprising images and in some embodiments the corresponding sound data) and generates a requested incident videoclip 324 that comprises images and, in some embodiments, sound, captured before the time of the detected incident, at the time of the detected incident, and after the detected incident. With this incident videoclip 324 providing a visual history around the time of the event (potential incident moment/timestamp 1102), the requested videoclip provides a context to the detected incident. The incident videoclip 324 comprises video data recorded during the detected-incident time period (time window) which comprises the incident timestamp (corresponding to the detected incident), a first pre-determined period before the detected incident (in other words, preceding the incident timestamp) and a second pre-determined period after the detected incident (in other words, following the incident timestamp).

For example, the context may involve another MHME (such as, for example, another forklift), encounter of a person, a human control error, information on the speed of the forklift 100, environmental conditions, etc.

At step 912, once the incident videoclip is packaged into the videoclip packet 324, the video recording device 140 transmits the videoclip packet 324 to the server 400.

At step 914, the server processor 402 of the server 400 executes the incident notification routine 416 (in other terms, the server processor 402 executes the computer instructions related to the incident notification routine 416). The server processor 402 stores the incident videoclip packet 324 the corresponding accelerometer data corresponding to the incident time period, and the detected incident timestamp. The server processor 402 generates a contextualized notification 334 (which may be also referred to as an “incident contextualized notification 334”) using the notification routine 416 and stores the contextualized notification 334 in a notification database 424 (FIG. 4) for access at any time. The server processor 402 also transmits the contextualized notification 334 to the notification device 220 of the manager 200 (FIG. 2).

The contextualized notification 334 is preferably transmitted to the notification device 220 within a very short period of time after the detected incident. The server 400 is configured to process in real time the history of the acceleration forces and other sensor readings of the monitored forklifts 100, and to perform the data exchanges with the video recording device 140 in a very short period after the determination of the incident. The video request 314 for the relevant video footage is transmitted immediately following the determination by the processor 402 of the server 400 that the potential incident is the detected incident. In at least one embodiment, instead of one notification, the server 400 sends an initial contextualized notification 335 and a second contextualized notification 336. In other words, in some embodiments, transmitting the contextualized notification 334 may comprise transmitting first the initial contextualized notification 335 and then the second contextualized notification 336. The initial contextualized notification 335 without the requested incident videoclip 324 may be transmitted to the manager device 220 immediately following the determination of the detected incident. A time delay may occur in the transfer of the requested videoclip 324 from the recording device 140 to the server 400. A second contextualized notification 336 has the incident videoclip 324 and is transmitted as soon as the transfer of the recording (incident videoclip 324) from the video recording device 140 to the server 400 is finished, and the requested videoclip 324 is available for sending. As the original conditions are visible in the the requested videoclip 324, the reaction time of the manager, for example, to avoid any manipulation of conditions related to the incident, isn’t important.

Accordingly, the server 400 is ready and generates and transmits the contextualized notification 334 at a time very close to the time of the incident, for example within 60 seconds from the time of the occurrence of the incident (i.e. the detected incident timestamp). Thus, even when not in real time, the contextualized notification 334 occurring so close to the time of the occurrence of the incident prevents occurring of changes in the conditions of occurrence of the incident and reducing the opportunities for manipulating the conditions of occurrence of the incident (for example, moving an object), allowing the manger 200 to investigate the incident with utmost efficiency.

At step 916, having received the contextualized notification 334, the notification device 220 displays at least a portion of the contextualized notification 334 on the notification device display 224. The notification device 220 may allow the manager 200 to access (open) and visualize additional details of the contextualized notification 334, including, for example, visualizing the incident videoclip. The contextualized notification 334 is designed to provide the manager 200 with various pertinent information to be able to decide how to proceed. For instance, the contextualized notification 334 may comprise an identification of the MHME/forklift 100 (MHME/forklift ID), when available location of the MHME/forklift 100, optionally identification of the driver of the MHME/forklift 100, optionally details on the acceleration forces undergone by the MHME/forklift 100, and the incident videoclip. The contextualized notification 334 may also comprise other data that was previously collected by the sensor 120 and transmitted to the server 400.

Steps 914 and 916 may take many forms, such as a single packet providing the information discussed hereinbefore. Notification (the contextualized notification 334) may be performed via an existing messaging service, such as, for example, short message service (SMS) or a messaging application, such as, for example, Facebook Messenger, WhatsApp, Email, etc. Thus, the present contemplates many alternatives. For example, the notification may be divided into several messages.

Communication between the server 400 and the accelerometer sensor 120 is a bi-directional communication, with the server 400 being able to provide packets 310 to the accelerometer sensor 120, for instance for firmware update, configuration, commands, and data request.

Referring to FIG. 8, the graph shows a non-limiting example of a history of registered acceleration forces along the three axes 162, 164, 166 (in other words, projections of the acceleration force on each one of the axes 162, 164, 166) in time (with reference to time, for example, with reference to timestamps or instances of measurement of the corresponding acceleration forces). Variations in the registered acceleration forces occur during normal operations, with these variations being not the same for the projections of the acceleration force on the different axes.

The server processor 402 of the system 102 as described herein may analyze the variation in time of the absolute value of the acceleration force projections on each one of the axes and may compare those values with each other. In at least one embodiment, the server processor 402 of the system 102 may compare the acceleration force projections for different axes with each other, for example, for the same timestamp or different (e.g. neighboring) timestamps.

In some embodiments, the system 102 as described herein may obtain the absolute value of the acceleration force and the corresponding angle of the acceleration force. Furthermore, durations of the peaks of the acceleration forces (for example, durations of the peaks of the acceleration force projections on at least one axis) may also vary depending on whether they occur during normal operations or being caused by an incident. The processor 402 may take into account duration of the peaks of the acceleration forces (and/or the acceleration forces projections) and, based on the duration of the peaks, determine whether the potential incident is the detected incident. In addition, in at least one embodiment, the server processor 402 uses the data collected earlier by the sensor 120 and transmitted to the server 400, such as for example and not limited to motion data and/or driving data, etc.

The processor 402 of the server 400 first detects that there was a potential incident, and then analyses data within the analysis period 1110 to determine whether the potential incident may be identified as the detected incident. The method 1000 as described herein takes into account the data collected earlier by the accelerometer sensor and additional sensors to determine whether there was the detected incident (in other words, to detect the incident) and identifying the “detected incident timestamp” corresponding to the time when the incident was registered by the accelerometer 120. It is the reason why incidents may be detected shortly after their occurrence. The system 102 and the method 1000 as described herein allow detecting the incidents shortly after their occurrence. The method 1000 described herein allows to avoid false detections of incidents.

Referring back to FIG. 9, incidents may also be declared. Declared incidents are declared by eyewitnesses rather than detected (classified) by the server 400. For instance, an eyewitness may consider that a forklift 100 may have been operated such that a dangerous situation may have been generated, without deteriorating into an incident. Nevertheless, the situation may be worth investigating. Such eyewitness would, for example, note the identification of the forklift 100, and the date and time of the situation. The information about a suspicious event (also referred to herein as a “declared incident” or a “potential incident”) may be received by the server, via e.g., a server terminal (not shown) or a server input device (such as a server keyboard or a touchscreen), an operation terminal (not shown) mounted to a forklift 100, or a notification device 220. The entry of a declared incident may trigger the following steps:

At step 908, the server 400 using the data acquisition routine 412 requests an incident videoclip from the video recording device 140, providing information on the time of the declared incident. For example, based on the time received from the eyewitness, the server 400 may generate a potential incident timestamp and request the incident videoclip using the video request 314. Such step may be performed regardless of the incident being a determined incident or a declared incident.

At step 910, the video recording device 140 generates, identifies and/or retrieves the incident videoclip 324 for the incident based on the received potential incident timestamp. The incident videoclip 324 may be, for example, a series of images and/or a video with sound and/or a video without sound.

At step 912, the video recording device 140 transmits the videoclip packet 324 to the server 400.

At step 914, the processor 402 of the server 400 generates a report of the declared incident and stores the report in the appropriate database of the server memory 406 (server database).

According to embodiments, declared incidents may have generated contextualized notifications associated therewith, or accessed upon request.

It is worth noting that the accelerometer sensor 120 is adapted for the forklift 100 travelling dead zones wherein no signal may be transmitted by the forklift 100 to the network. The system 102 is adapted to retransmit packets when, for instance, no transmission acknowledgement is received. With these situations, even when no live detection of incidents is possible, delays before detection of incidents are kept to a minimum.

It is further worth noting that the described embodiment involves storing videos on video recording device 140 and erasing oldest videos when space is necessary to store new videos. In at least one embodiment, videoclips generated by the video recording device 140 may be flagged when associated with a detected or declared incident, and stored at the video memory 146 with such an incident-related flag. When the videoclip is associated with the incident-related flag, such videoclip may be stored in memory longer, and be object of a different protocol of management of memory space. For example, the video memory 146 may be requested to be cleaned, for example such request may be received from the server processor 402, while the videoclips associated with (flagged) with the incident-related flag may be preserved from deletion and cleaning (i.e. requested to be kept in the video memory longer than other video files).

In alternative embodiments, videos not associated with incidents may also be transmitted to the server 400 for archiving.

In alternative embodiments, the video recording device 140 may transmit continuously the videos to the server 400 and stored in the server video database 420, with the server 400 generating the videoclips as described herein in response to receiving a timestamp from the data acquisition routine 412 to provide context to an incident. For example, a video acquisition routine 418 may be then provided on the server to extract the videoclip based on the incident timestamp (in some embodiments, based on the first and last timestamps of the videoclip) from such video database 420. Based on parameters such as warehouse network speed, number of MHME/forklifts 100 and video recording device 140, etc., the described embodiment minimizing the amount of data communicated, or the latter embodiment may be selected.

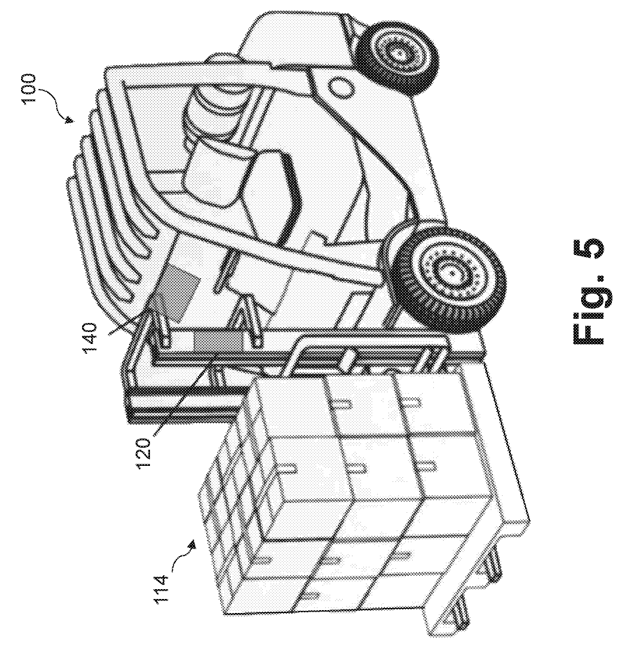

FIGS. 5, 6, 7 and 8 schematically illustrate non-limiting examples of operation of the method as described herein.

Referring to FIG. 5 and FIG. 8, FIG. 5 depicts the forklift 100 during the operation of the method 1000 as described herein. In FIG. 5, there is no reason for an incident to be detected. A first time window 820 in FIG. 8 corresponds to the illustration of FIG. 5. The first time window 820 in FIG. 8 depicts non-limiting example of registered acceleration forces along axes 162, 164, 166 when operating according to normal operations, comprising acceleration and deceleration of the forklift 100.

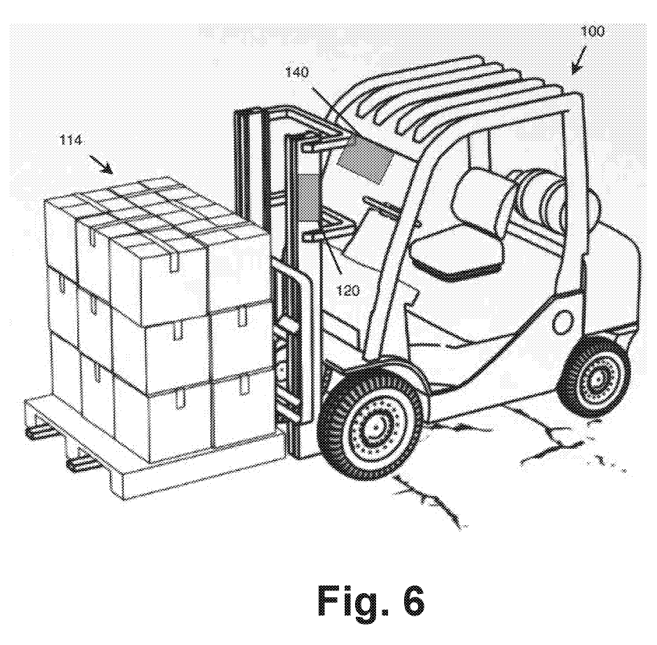

Referring now to FIG. 6 and FIG. 8, FIG. 6 depicts the forklift 100 passing over an uneven portion of the floor, for example, a cracked portion of the floor. Such an event may occur in normal operation and may generate a number of peaks in acceleration forces along the axes 162, 164 and 166 shown via a second time window 830 in FIG. 8. However, the history of the acceleration forces (the acceleration forces before the second time window 830) and relationship of the changes of the acceleration forces along the three axes 162, 164, 166 allows the server 400 to determine that the situation (event) does not fulfil the criteria of an incident.

In at least one embodiment, such incident criteria may comprise at least one of: acceleration forces along (their projections to) the axes 162, 164, 166 (for example, two, three, or more axes), and/or their combination that are/is under a pre-determined acceleration force threshold; movement directions of the forklift 100 before and after the peaks registered in the acceleration forces; registered motions of the forklift 100, including e.g. start, stall, rapid side displacements; speed of the forklift 100 exceeding (or not exceeding) a pre-determined speed threshold; identified location corresponding to a pre-determined location, identified change of direction corresponding to a pre-determined location obtained, etc. For example, such incident criteria and pre-determined threshold may be adjusted prior to operation of the system using the input devices (e.g. a keyboard, a touchscreen, etc.) of the server 400 or of the manager device 220. The data collected by the sensor 120 and transmitted to the server 400 may be analyzed.

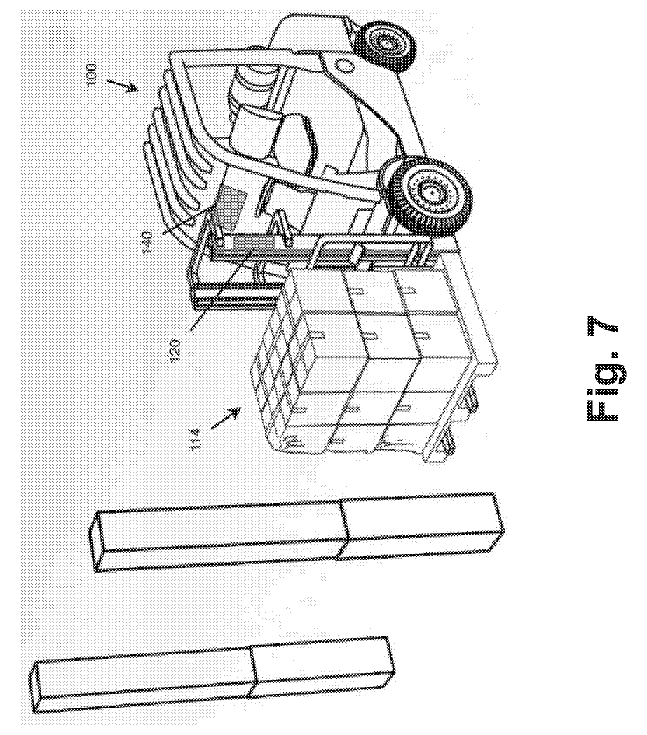

Referring to FIG. 7 and FIG. 8, FIG. 7 depicts the forklift 100 immediately after hitting a column. As illustrated, the integrity of goods 114 on the transported pallet may be affected by the collision. This situation fulfills the condition of an incident and the server processor 402 would determine that the incident criteria are fulfilled. A third time window 840 illustrated in FIG. 8 shows that the acceleration forces registered offer a greater amplitude in association with this situation, and the difference between the acceleration forces registered along the X axis 162 are far more important than the acceleration forces registered along the Y axis 164 and the Z axis 166. When analyzing data contained in the third time window 840, the server 400 would detect an incident and trigger the contextualization process of the detected incident and generate the notification of the detected incident to transmit the notification to the manager 200.

Generation of contextualized notifications with short delays may allow and significantly help the manager in the investigation of the detected incident. The short delay allows to and helps to minimize non-operating time by, e.g., allowing the manager to contact the MHME/forklift 100 driver shortly after the situation source of the detected incident to e.g., inform the driver to continue working or wait for the manager to reach the location of the detected incident. The system as described herein helps to avoid generating notifications with reference to incidents that are related to normal operation (for example, uneven flooring, transition between a trailer and a facility (or a container and the facility), standard manipulation of goods resulting in forces felt by the equipment, cracked flooring, uneven surfaces in various types of industrial environments) of the MHME, as such false positive notifications (i.e. when the system erroneously detects the incident) may decrease confidence of the managers and other users of the system.

The notification received by the manager’s device 220 comprises a contextualization of the detected incident comprising the videoclip, allowing the manager 200 to determine if the incident is worth investigating without any forced downtime in the operation of the MHME/forklift 100, for example, while the MHME/forklift 100 is still at the location of the incident.

The system and method as described herein may be adjusted (customized) to needs and conditions of the MHME and the industrial environment.

For example, the sensitivity of the system 102 to detect incidents may be adjusted to different MHME and the corresponding industrial environment. The parameters and/or thresholds that are used by the system and method to detect an incident may be modified/adjusted according to the type of goods they are moving, conditions of the warehouse, e.g., characteristics related to evenness (uniformity) of the floor of a warehouse, and/or condition of the MHME operating both inside and outside of the warehouse, construction sites or other industrial environment. The evenness (uniformity) of the floor may be characterized, for example, by various parameters related, for example, to the surface flatness or smoothness (lack of bumps) and the surface levelness.

For instance, with goods that are fragile, and moved in a warehouse having an almost perfect floor, the manager may want the system 1000 to be very sensitive, and to determine incident when the acceleration forces show a low level of instability. For another example, in a warehouse transporting heavy goods, the sensitivity is desired to be less (lower) since any unevenness of the floor will lead to greater spikes in the acceleration forces when occurring when the forklift is transporting the goods. These two examples demonstrate the variability of the conditions and the requirement for customization and configuration in order to get a great ratio of detected true incidents versus detected false incidents.

Customization may involve the context recorded and/or included in the notifications. For instance, the time period covered by videoclips may be customized, as the time period transmitted in or mandatorily associated with the notification. Non-mandatory (optional) additional context may be provided on request (after, for example, receiving a manager request 340 from the notification device 220, for example, using the manager device’s keyboard and/or a touchscreen 226) to the manager after the notification has been delivered to the manager device (for example, when or after the manager looks at / examines the notification). The system 1000 as described herein may be customizable in such a way or in other ways without departing from the scope of the described solution.

Customization of the method and system as described herein may involve various locations of the video recording device(s), and the number of video recording device(s) mounted to the forklift. In the illustration of the described embodiment, one video recording device is mounted above the steering wheel. In other situations, it may be deemed more appropriate to have an additional video recording device covering the rear of the forklift, and/or for example on the sides. Depending on the structure of the forklift, one additional video recording device may be dedicated to the controls while the other additional video recording device may be dedicated to the front environment. Since the video recording devices are operating independently, having unique IDs that may easily be associated with a forklift in a database, more than one video recording device may be associated with a forklift, and additional video recording device(s) may be added sometimes after the initial setup of the system as described herein.

In at least one embodiment, the system as described herein may also comprise numbers of accelerometer sensors having various locations on the MHME. Based on the models of forklifts, the goods, the operation of the MHMEs/forklifts, preferable location to mount the accelerometer sensor to the MHME/forklift may vary. And similarly to the video recording device(s), more than one accelerometer sensor may be mounted, and added after the initial setup.

According to at least one embodiment, the accelerometer sensor 120 and video recording device 140 are not connected to the controls of the MHME/forklift 100. Thus, operation of the MHME/forklift 100 by its driver may begin with turning up the accelerometer sensor(s) 120 and video recording device(s) 140. According to other embodiments, the electric feed of the accelerometer sensor(s) 120 and of the video recording device(s) 140 may be linked to the forklift 100, turning on the accelerometer sensor(s) 120 and the video recording device(s) 140 when turning on the forklift 100. It is therefore contemplated therethrough that many variations may be realized without affecting the way the system operates.

Initial setup of a forklift in the system as described herein may be rapidly described. For example, the accelerometer sensor(s) 120 and video recording device(s) 140 may be first associated with each other, and then mounted (attached) to the forklift 100, with the components entities and the forklift entity (for example, their IDs) being registered in the database and associated with each other. The configuration may comprise setting up the sensitivity that may be set warehouse-wise (or potentially individually per forklift).

According to embodiments, the pre-processing operations, and thus the nature of the data transmitted by the accelerometer sensor 120 may vary from registered data to highly processed data. Selection of the data and amount of pre-processing is a question of processing capability of the accelerometer 120, as amount of data to be exchanged between the accelerometer sensor 120 and the server 400. According to various embodiments, based on different factors such as processing capability and value associated with some data, different technical solutions may be made while providing a system and a method that substantially corresponds to the present solution for detecting incidents and providing contextualized notifications of the detected incidents.

In relation to alternatives and variations to the system, there is herein described a video recording device with a very wide lens offering a field of view of about 180 degrees in every direction. This type of lens is selected for providing enough (sufficient) information (for the following analysis) with a single video recording device 140. However, video recording devices with narrower or broader fields of view may be selected in other conditions without departing from the described technology.

Based on conditions, the type of wireless communication with a device may vary or may be multiple. For instance, a device in one embodiment may be set to exchange data only over Wi-Fi while in another embodiment the device may be set to exchange data over any network such as, for example, Wi-Fi, LTE, 5G cellular network, Cat-M1, Ethernet, etc.

The system and method described herein may be set up (adapted) to limit the context specific to different industrial environments (such as, for example, warehouses, construction sites, manufacturing plants, distribution centers, etc.). For instance, based on union contracts, the system may or may not be permitted to record behavior of the drivers other than the driver operating the steering wheel of the MHME (such as the forklift 100). Locations and field of view of the video recording device(s) may thus be selected and adjusted accordingly.

Preferably, the video recording is extracted from the recording devices installed on the MHME 100 (MHME recording devices), and not through additional static video recording devices installed in the warehouse. The video recording extracted may be related to any moment and may be extracted from the recording devices at any time. In at least one preferable embodiment, the recording devices record video data continuously, and therefore any video recording may be extracted on demand, comprising, for example, video recordings which may be or may be not related to the potential incident or the detected incident.

In some embodiments, e.g., static video recording devices may be installed in the warehouse.

The MHME 100 may be equipped with location sensors. A similar process of transmitting a request (video request) and receiving a videoclip may be performed with one or more of these video recording devices when there is determined that the detected incident is within the field of view of one or more of these video recording devices. Videoclips of the static video recording devices may be automatically requested for additional contextualization or may be requested only upon a request from a manager. Accordingly, in view of the autonomous operation of the video recording devices, additional contextualization may be achieved with low additional weight over the system.

In at least one embodiment, the method for notifying of an incident involving the MHME 100 comprises: receiving, by a server, in a continuous manner acceleration forces detected by an accelerometer mounted to the MHME, the acceleration forces along at least two axes, and timestamps corresponding to the acceleration forces and identifying time of detection of the acceleration forces; analyzing the acceleration forces detected in a time window, and determining an incident timestamp when the acceleration forces fulfill at least one incident condition; generating and transmitting, by the server, a video request to a video recording device mounted to the MHME, the video recording device recording in a continuous manner images and corresponding timestamps identifying time of recording of the images; receiving, by the server from the video recording device, an incident videoclip comprising video images spanning over an incident time period comprising the determined incident timestamp therein; generating and transmitting a notification of the detected incident to a manager device remote from the MHME, wherein the notification comprises the incident videoclip.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for notifying of an incident involving a material handling and moving equipment (MHME), the method comprising:
generating and recording video data and corresponding timestamps therewith, by a video recording device having a local memory storage configured to store images and the corresponding timestamps, the video recording device being attached to the MHME;
detecting, by an accelerometer sensor, acceleration forces with reference to each one of three axes, the accelerometer sensor processing the acceleration forces to determine a potential incident and potential incident timestamp and transmitting data relative to the potential incident to a server or the acceleration sensor transmitting continuously detected accelerations forces to the server;
analyzing the acceleration forces within an analysis period comprising time windows before and after the potential incident timestamp, based on incident criteria and determining, by a server processor, whether a detected incident has occurred and determining an incident timestamp corresponding to a moment of the detected incident, and generating a video request;
upon receiving the video request by the video recording device, the video request comprising the incident timestamp from the server associated with the detected incident, transmitting, by the video recording device, to the server, an incident videoclip comprising the video data recorded during a video recording time window comprising the incident timestamp, a first pre-determined period before the detected incident and a second pre-determined period after the detected incident; and
generating, by the server, a contextualized notification corresponding to the detected incident and transmitting to a manager device located remotely from the MHME, via a communication network, the contextualized notification comprising the incident videoclip providing contextualization of the incident.

2. The method of claim 1, wherein generating and recording images and the corresponding timestamps is executed in a continuous manner.

3. The method of claim 1, wherein storing the images and the corresponding timestamps is executed in a continuous manner.

4. The method of claim 1, wherein determining, by the server processor, whether the detected incident has occurred further comprises analyzing additional data from additional sensors.

5. The method of claim 1, wherein the accelerometer data further comprises location of the MHME.

6. The method of claim 1, wherein transmitting the contextualized notification comprises transmitting an initial contextualized notification followed by transmitting a second contextualized notification, the second contextualized notification comprising the incident videoclip.

7. The method of claim 1, wherein analyzing the acceleration forces further comprises analyzing variation in time of an absolute value of acceleration force projections on each one of the axes and compare the values of the acceleration force projections with each other.

8. The method of claim 1, wherein analyzing the acceleration forces further comprises comparing acceleration force projections for different axes with each other.

9. The method of claim 1, further comprising determining whether the potential incident is the detected incident based on a duration of peaks of the acceleration forces.

10. A system for notifying of an incident involving a material handling and moving equipment (MHME), the system comprising:
an accelerometer sensor configured to detect and register accelerometer data comprising timestamps during a first time period;
a video recording device configured to generate and register video data, and transmit, upon receiving a video request, an incident videoclip comprising images recorded during a time window;
a database configured to receive and store the accelerometer data and additional sensor data; and
a server configured to:
receive the accelerometer data and analyze acceleration forces based on incident criteria and determining, by a server processor, whether a detected incident has occurred and determining an incident timestamp corresponding to a moment of the detected incident, and generate and transmit the video request to the video recording device;
receive the incident videoclip comprising the images recorded during the time window comprising the incident timestamp, a first pre-determined period before the detected incident and a second pre-determined period after the detected incident; and
generate an incident notification corresponding to the detected incident and transmit to a manager device located remotely from the MHME, the incident notification comprising the incident videoclip providing contextualization of the incident.

11. The system of claim 10, wherein generating and recording the images and corresponding timestamps is executed in a continuous manner.

12. The system of claim 10, wherein storing the images and corresponding timestamps is executed in a continuous manner.

13. The system of claim 10, wherein determining, by the server processor, whether the detected incident has occurred further comprises analyzing additional data from additional sensors.

14. The system of claim 10, wherein the accelerometer data further comprises location of the MHME.

15. The system of claim 10, wherein transmitting the contextualized notification by the server comprises transmitting an initial contextualized notification followed by transmitting a second contextualized notification, the second contextualized notification comprising the incident videoclip.

16. The system of claim 10, wherein analyzing the acceleration forces further comprises analyzing variation in time of an absolute value of acceleration force projections on each one of axes and comparing the values of the acceleration force projections with each other.

17. The system of claim 10, wherein analyzing the acceleration forces further comprises comparing acceleration force projections for different axes with each other.

18. The system of claim 10, further comprising determining whether a potential incident is the detected incident based on a duration of peaks of the acceleration forces.

19. The system of claim 10, wherein the MHME is a forklift.

20. A method configured to be executed by a system comprising:
an accelerometer sensor configured to register accelerometer data comprising timestamps;
a video recording device configured to register video data, the video recording device having a database for storing the video data;
a server configured to receive the accelerometer data and the video data; and
a database configured to receive and store the accelerometer data and additional sensor data;
the method comprising:
receiving, from the accelerometer sensor installed on a material handling and moving equipment (MHME), the accelerometer data comprising an acceleration force and location of the MHME;
determining whether an incident has occurred based on incident criteria, comprising comparing of amplitudes of acceleration forces along at least two axes registered over a time window with pre-determined amplitudes of the acceleration forces and determining an incident timestamp associated with the time of the incident;
requesting based on the incident timestamp and receiving, from the video recording device, an incident videoclip comprising the video data within an incident period of time comprising data before, during and after the incident timestamp; and
generating and transmitting an incident notification to a manager device, the notification comprising contextualization comprising the incident videoclip.
